(19) United States
(12) Patent Application Publication
(10) Pub. No.: US 2016/0335223 A1
(43) Pub. Date: Nov. 17, 2016

(54) METHODS AND SYSTEMS FOR COMPUTATION OF BILEVEL MIXED INTEGER PROGRAMMING PROBLEMS

(71) Applicants: Bo Zeng, TAMPA, FL (US); Yu An, Tampa, FL (US); Long Zhao, Carmel, IN (US)

(72) Inventors: Bo Zeng, TAMPA, FL (US); Yu An, Tampa, FL (US); Long Zhao, Carmel, IN (US)

(73) Assignee: UNIVERSITY OF SOUTH FLORIDA, TAMPA, FL (US)

(21) Appl. No.: 14/721,367

(22) Filed: May 26, 2015

Related U.S. Application Data
(60) Provisional application No. 62/018,101, filed on Jun. 27, 2014.

(51) Int. Cl. G06F 17/11

(52) U.S. Cl. CPC G06F 17/11

(57) ABSTRACT

Techniques and systems are disclosed for improving the computation and solution of bilevel MIP problems. Various single-level reformulation techniques can be used to transform a bilevel MIP problem into soluble form. Decomposition techniques can be applied to the single-level reformulations to iteratively converge on an optimal or near-optimal solution. Some techniques described herein are operative within software applications for solving mathematical problems or MIP problems, and some are operable within an application programming interface or MIP solution service that other software components can access. In some cases, the techniques may be operative within domain-specific modeling software that solves, models, plans, or suggests actions in particular scenarios, for example power grid interdiction analysis and defense tools.

### CROSS-REFERENCE TO RELATED APPLICATIONS

This application claims the priority benefit of U.S. Provisional Application Ser. No. 62/018,101, filed Jun. 27, 2014, which is incorporated herein by reference in its entirety.

### BACKGROUND OF THE INVENTION

Bilevel optimization is an optimization scheme to model a non-centralized system that has two decision makers (DMs) at different levels driven by their own interests. Decisions made by the upper-level DM affect the feasible decision set of the lower-level DM, while an equilibrium response, i.e., an optimal decision, from the lower-level constitutes a part of the performance evaluation of the upper-level. Indeed, because of a sequential interaction between them, this decision making structure is also called Stackelberg leader-follower game. By defining two optimization problems for those DMs respectively, the whole structure can be formulated as the following bilevel optimization model:

BiMIP: Θ*=min fx+gy+hz (1)

s.t. Ax≦b,x∈ [symbol] ₊^{m}^{_{c}}× [symbol] ₊^{m}^{_{d}}, (2)

(y,z)∈ [symbol] (x)≡arg max{wy+vz:Py+Nz≦R−Kx,y∈ [symbol] ₊ⁿ^{_{c}},z∈ [symbol] ₊ⁿ^{_{d}}}. (3)
where x represents the upper-level decision variables, y represents the lower-level continuous decision variables, and z represents the lower-level discrete decision variables. The differentiation between y and z is to streamline the remaining discussion. The membership requirement in Equation (3) ensures that an optimal solution of the lower-level DM is fed back to the upper-level DM. Formulation BiMIP is often referred to as optimistic bilevel formulation, since the upper-level DM is able to select (y, z), if F(x) is not a singleton, for the upper-level DM's own favor.

Since its introduction in the 1970s [11, 16], bilevel optimization has received enormous research attention and has been widely applied to study and support many practical hierarchical decision-making problems. Such situations happen very often in transportation planning and network capacity expansion [12, 19, 36], government policy making [8, 18], revenue management [13, 20], and computational biology [42, 15]. With deregulations of power systems and organizations of electricity markets, bilevel and general multilevel optimization have been applied to deal with various management challenges between market administrators and participants, including power generation, market bidding, and capacity expansion [44, 28, 32, 26, 39]. Moreover, the interdiction model, a special class of bilevel optimization model, where the upper-level and lower-level DMs have completely opposite interests, has been intensively utilized in military and homeland security applications for strategic planning and system vulnerability analysis [2, 45, 10, 14, 34].

Although it is widely applied in modeling and analyzing practical problems, computing bilevel mixed integer programming (MIP) problems, i.e., BiMIP in Equations (1-3), is not easy. Even for the simplest bilevel linear programming (LP) problem, wherein both upper- and lower-level problems are linear programs, it is theoretically NP-hard [25, 3]. Yet, using results of Karush-Kuhn-Tucker (KKT) optimality conditions or strong duality from linear programming theory, bilevel LP is often converted into an LP with complementarity constraints or a mixed integer program (MIP), which yields a computationally feasible approach to solve practical issues. Indeed, because those crucial structural properties are only applicable to LP, the majority of existing research efforts do not consider general BiMIP with mixed integer lower-level problems. Up to now, only a few algorithms have been developed [22, 37, 50, 51] that are able to compute bilevel problems whose lower-level problem has discrete variables. Nevertheless, those algorithms either (i) heavily depend on enumerative Branch-and-Bound strategies based on a rather weak relaxation, or (ii) involve complicated operations that are problem specific and challenging for most researchers and practitioners to implement. Hence, existing methods are of very limited computational capability. As a consequence, there is no commonly accepted approach, and little support is available to transform BiMIP into a decision-making tool for real system practice. Given such a situation, some researchers consider BiMIP as an unsolved problem in the operations research community.

Although various software techniques have been designed and developed for general or structured single-level MIP, computing bilevel MIP remains challenging. One fundamental reason is that the bilevel formulation in Equations (1-3) is defined in a rather implicit way. Let 3-tuple (x, y, z) represent one solution of BiMIP. Its feasible set, which often called the inducible region, is defined in the following parametric fashion.

Ω^{I}={(x,y,z):Ax≦b,(y,z)∈ [symbol] (x),x∈ [symbol] ₊ⁿ^{_{c}}× [symbol] ₊ⁿ^{_{d}}}.

Analyzing such a parametric representation and developing structural insights is difficult. However, under a special situation where the lower-level problem is a pure LP, i.e., no z variables and n_{d}=0, the mathematical representation of Ω^{I} can be drastically simplified. For an LP problem with a finite optimal value, its KKT conditions, which include primal feasibility, dual feasibility, and complementary slackness conditions, are necessary and sufficient to characterize an optimal solution. In other words, those KKT conditions can be used to characterize optimal solutions. Hence, F(x) can be replaced by the corresponding KKT conditions [24]. As a result, Ω^{I} can be reformulated into the following set with linear and disjunctive constraints (from complementary slackness conditions in equation (6)), where it is the vector of dual variables with appropriate dimension n₁. For ease of exposition, ⊥ signs are employed herein to compactly represent complementarity conditions.

Ω^{I}={x∈ [symbol] ₊ⁿ^{_{c}}× [symbol] ₊^{m}^{_{d}},y∈ [symbol] ₊ⁿ^{_{c}}, π∈ [symbol] ₊ⁿ^{₁}:Ax≦b, (4)

Py≦R−Kx,P^{t}π≧w^{t}, (5)

y⊥(P^{t}π−w^{t}),π⊥(R−Kx−Py)}. (6)

Therefore, BiMIP is equivalently converted into the following single-level optimization model:

min{fx+gy: (4)-(6).} (7)

This kind of single-level reformulation provides a great convenience in designing computing algorithms. For example, the disjunctive structure displayed in Equation (6) motivates many Branch-and-Bound methods, including [24, 6, 7, 27, 49]. Actually, BiMIP with Ω^{I} in Equations (4-6) is a mathematical program with linear complementarity constraints (MPCC) [47], which can be solved by nonlinear programming algorithms [43, 31, 41, 29]. Moreover, constraints of complementary slackness conditions can be linearized using additional binary variables [3] along with nonnegativity properties of decision variables. Specifically, consider a complementary slackness condition πᵢ(R−Kx−Py)ᵢ=0, where subscript i is to denote i^{th} component of the associated vector. It is equivalent to

πᵢ≦Mδᵢ,(R−Kx−Py)ᵢ≦M(1−δᵢ),δᵢ∈{0,1} (8)
where M is a sufficiently large number. By applying this conversion to every complementary slackness condition, the whole BiMIP formulation then can be reformulated into a regular MIP problem. Indeed, in concert with powerful professional MIP solvers, this MIP reformulation strategy has been widely employed, as it allows researchers and practitioners to compute BiMIP instances with little effort designing sophisticated algorithms.

A natural connection between single-level MIP and bilevel MIP can be established if (y, z) is required to be feasible, instead of optimal, for a given x. Then, bilevel MIP reduces to the following single-level MIP, which is called high point problem [37].

$${φ}^{*} = {min}_{( x , y , z ) ∈ Ω} ( fx + gy + hz )$$

where

Ω={x∈ [symbol] ₃₀ ^{m}^{_{c}}× [symbol] ₃₀ ⁿ^{_{d}},y∈ [symbol] ₊ⁿ^{_{c}},z∈ [symbol] ₊ⁿ^{_{d}}:Ax≦b,Py+Nz+Kx≦R}.

Thus, Ω^{I} ⊂ Ω and high point problem is a relaxation to BiMIP. Indeed, it has been proven in [17, 9, 5] that when both upper- and lower-levels are LP problems, i.e., m_{d}=n_{d}=0, an optimal solution to BiMIP will be an extreme point of Ω. Hence, some methods have been developed to identify an optimal solution by evaluating extreme points of Ω, which is often referred to as vertex enumeration, in an efficient way [17, 40, 4, 9]. Nevertheless, those vertex enumeration methods only work for those with LP upper- and lower-level problems. On the contrary, the KKT conditions-based reformulation strategy is more general as it does not restrict the upper-level to be an LP.

When the lower-level problem has discrete variables, which renders KKT conditions invalid, solution methods become scarce. Among a variety of techniques [37, 22, 50, 46] developed over the last 20 years, almost all of them are directly implemented with Branch-and-Bound techniques [37, 22, 50, 46, 51], which are more suitable for pure IP lower-level problems [22, 50]. Actually, high point problem is generally adopted as the fundamental relaxation within those Branch-and-Bound schemes. However, as demonstrated in [37], this relaxation is very weak, leading to very large Branch-and-Bound trees that require a long computation time. To improve performance of Branch-and-Bound methods, fast heuristic variants are designed [37], cutting planes are generated for strengthening [22], and a sophisticated master-sub problem decomposition method is designed to guide the branching process and to create nodes [50]. Different from Branch-and-Bound methods, a parametric integer programming approach is developed in [33]; however, the approach is a conceptual method with no numerical evaluation.

The interdiction model, as a structured bilevel optimization problem, is formulated as the following:

$${Θ}^{*} = {min}_{x} {max}_{( y , z ) ∈ {0}^{} ( x )} wy + vz \qquad ( 9 )$$

where [symbol] ⁰(x)={y ∈ [symbol] ₊ⁿ^{_{c}}, z ∈ [symbol] ₊ⁿ^{_{d}}: Py+Nz≦R−Kx}. Because the gain of one level is exactly the loss of the other one, it represents a zero-sum game and is widely employed in decision-making and analysis of security and defense applications. When the lower level is an LP, the interdiction model is often reformulated into a single-level problem with a bilinear objective function as in Equation 10, based on the strong duality (with it satisfying all constraints in the dual problem).

$${min}_{x} {max}_{y ∈ {0}^{} ( x )} wy ⇔ {min}_{x , π} π ( R - Kx ) . \qquad ( 10 )$$

In many cases [2, 1, 38], especially for network interdiction applications, x are binary variables. The nonlinear products between x and it can thus easily be linearized, and the whole formulation is converted into an MIP. Compared with the reformulation based on KKT conditions, this formulation has fewer variables and constraints and typically has lower computational demands [2]. Certainly, as one type of BiMIP, neither reformulation strategy is applicable when discrete variables appear in the lower-level. Nevertheless, because network interdiction problems often demonstrate clear structural properties, some specialized computing methods have been developed for those with mixed integer lower-level problems [46, 21].

Overall, for BiMIP with an LP lower-level problem, the single-level reformulation strategy based on KKT conditions is arguably the most popular solution method. In particular, the MIP representation of that reformulation, in concert with existing powerful MIP solvers, provides a convenient and efficient computing approach. As a result, this type of BiMIP has been employed as an analytical tool in decision-making about real-world problems. Nevertheless, for BiMIP with a MIP lower-level problem, the situation is very different. Although several computing methods have been proposed or designed, they are either designed to target problems with special structures or their implementations involve sophisticated analysis and complicated operations. Also, the popular high point problem relaxation is weak, which indicates the associated Branch-and-Bound schemes are less effective. Hence, up to now, there is no commonly-accepted technique for computing this general type of BiMIP. Without support of effective solution methods or computing tools, some researchers consider general BiMIP “still unsolved by the operations research community” [21]. Consequently, its application in addressing real problems is very restricted.

### BRIEF SUMMARY

Techniques and systems are disclosed for improving the computation and solution of bilevel mixed integer programming (MIP) problems. Embodiments of the subject invention use various single-level reformulation techniques to transform a bilevel MIP (BiMIP) problem into soluble form. Certain embodiments apply decomposition techniques to the single-level reformulations to iteratively converge on an optimal solution.

Embodiments of the subject invention may transform a BiMIP problem into an alternate formulation that duplicates decision variables and constraints of the lower-level problem. In some embodiments, it is assumed that the problem has a finite optimal solution. In other embodiments, when the problem does not have a finite optimal solution, the reformulation techniques can be applied to derive ε-optimal solutions (i.e., optimal within an optimality tolerance), which can be sufficient or useful in solving certain practical problems.

Embodiments of the subject invention apply decomposition techniques to one or more reformulation to converge on optimal, or ε-optimal, solutions. Embodiments using decomposition techniques include restructuring a given bilevel MIP problem, in its reformulated form, as a master problem and a subproblem that can be iteratively computed to converge the optimal upper and lower bounds of the solution. In certain embodiments, the master problem can be reformulated into an augmented form which induces a stronger lower bound and thus improves computational efficiency.

Certain embodiments of the techniques described herein are operative within software applications for solving mathematical problems or MIP problems. Some embodiments are operable within an application programming interface or MIP solution service that other software components can access. In some cases, the techniques may be operative within domain-specific modeling software that solves, models, plans, or suggests actions in particular scenarios, for example power grid interdiction analysis and defense tools. The disclosed techniques produce advantageous technical effects that improve the processing capability and performance of software, hardware, and software-hardware systems that attempt to compute MIP solutions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1B show the feasible set of results from an example embodiment using a reformulation of a BiMIP problem.

FIGS. 2A-2B show the feasible set of results from an example embodiment using a reformulation including strong duality conditions.

FIG. 3 shows plotted results from an example embodiment. FIG. 4 shows a block diagram illustrating components of a computing device or system used in some implementations or embodiments.

### DETAILED DISCLOSURE

Techniques and systems are disclosed for improving the computation and solution of bite-vet mixed integer programming (MIP) problems. Embodiments of the subject invention use various single-level reformulation techniques to transform a bilevel (BiMIP) problem into soluble form. Certain embodiments apply decomposition techniques to the single-level reformulations to iteratively converge on an optimal solution.

Embodiments of the subject invention may transform a BiMIP problem in the form of Equations (1)-(3) into an alternate formulation BiMIP_{d} (Equations (12)-(15), below) that duplicates decision variables and constraints of the lower-level problem. In some embodiments, it is assumed that the problem has a finite optimal solution. In other embodiments, when the problem does not have a finite optimal solution, the reformulation techniques can be applied to derive ε-optimal solutions (i.e., optimal within an optimality tolerance), which can be sufficient or useful in solving certain practical problems.

Some embodiments can further reformulate a bilevel MIP problem when certain conditions apply to the problem domain or constraints of the problem. In an embodiment, for instance, an assumption about the problem that, for any possible (x, y), the remaining lower-level problem has a finite optimal value (i.e., has the “relatively complete response” property), yields a single-level reformulation. In another embodiment, an assumption that the problem does not have the relatively complete response property yields an extended formulation wherein additional variables with penalty coefficients are introduced to compensate constraint violations. In another embodiment, an assumption that the problem is constrained by strong-duality conditions (e.g., when x is binary) yields a strong-duality-based reformulation. Additional details and examples of these embodiments are described below.

Embodiments of the subject invention apply decomposition techniques to one or more of the reformulations described above to converge on optimal, or ε-optimal, solutions. Embodiments using decomposition techniques include restructuring a given bilevel MIP problem, in its reformulated form, as a master problem and a subproblem that can be iteratively computed to converge the optimal upper and lower bounds of the solution. In certain embodiments, the master problem MP can be reformulated (to MP_{aug}) to have a larger optimal value, which induces a stronger lower bound than MP and thus improves computational efficiency.

Certain embodiments of the techniques described herein are operative within software applications for solving mathematical problems or MIP problems. In some implementations, the techniques may be operative within domain-specific modeling software that solves, models, plans, or suggests actions in particular scenarios, for example power grid protection, transportation planning, network capacity expansion, government policy-making, revenue management, computational biology, and power system capacity, generation, and bidding. In some embodiments, techniques may be implemented in the form of an application programming interface (API) that one or more other software applications may access to solve bilevel MIP problems. Such an API may be installed in a code module that forms part of a software solution, or the API may be made available to a software solution via, for example, a bilevel MIP solution service. The API may be accessible to the software solution, for example, using a representational state transfer (RESTful) interface that receives a particular problem and constraints and returns a solution. Examples of mathematical software applications include Analytica Optimizer from Lumina® and various kinds of analysis software from SAS®. An example of an API is the Solver SDK from Frontline Systems.

Technical features of the disclosed techniques produce advantageous technical effects that improve the processing capability and performance of software, hardware, and software-hardware systems that attempt to compute MIP solutions. On a set of random instances, embodiments may produce optimal solutions within a small number of iterations, demonstrating superior performance over existing techniques. A study of certain computational improvements is discussed below in the Examples section.

Furthermore, in some cases, the improved computational capability of the disclosed techniques may make soluble a problem that was previously insoluble due to time or computational capacity constraints. For example, a power grid interdiction problem may be relevant to solve only when it can be solved within a time period that responds effectively to minimize damage. In other words, if the proper response takes too long to compute, it may be pointless to compute. Thus, an ability to compute a response in a shorter time, as techniques of the subject invention can allow, may enable adaptive software to be developed that can protect a power grid.

In addition, a given embodiment can involve flexible reformulations meeting various conditions (e.g., the relatively complete response property, strong duality) as well as a decomposition technique that iteratively probes for an optimal solution using the chosen reformulation. Thus, the techniques allow a general approach to bilevel MIP problems that can be tailored for further efficiencies based on the specific character of the problem and its constraints.

Additional information regarding the implementation of these embodiments, and others, are presented below to demonstrate the soundness, advantages, and computational improvements of the techniques and systems of the subject invention.

Reformulation of a Bilevel MIP Problem

In certain embodiments, a computing problem in the BiMIP form can be reformulated and simplified with certain conditions and assumptions, shown below as Proposition 1.

Proposition 1:

1. If high point problem is infeasible, BiMIP is infeasible.

2. If (g, h)=α(w, v) with α≦0, BiMIP reduces to high point problem.

3. If(g, h)=α(w, v) with α>0, BiMIP reduces to

$${Θ}^{*} = {min}_{x ∈ X} fx + α {max}_{( y , z ) ∈ {0}^{} ( x )} wy + vz . \qquad ( 11 )$$

For the purposes of the techniques described herein, an assumption is that high point problem is feasible and Ω (the feasible set) is not empty. Nevertheless, it is observed that, even though Ω is not empty, provided that there are discrete decision variables in the lower-level, i.e., n_{d} is non-zero, BiMIP may not have any optimal solution. Under such situations, min should be replaced by inf in Equation (1). In some embodiments, to concentrate on designing computing algorithms for BiMIP, it is assumed that it has a finite optimal solution (x, y, z). In some embodiments, when inf cannot be reduced to min, the disclosed techniques can be applied to derive ε-optimal solutions, which can be sufficient or useful in solving practical problems.

Most existing research on solving bilevel MIP directly studies the BiMIP formulation in Equations (1)-(3) and seeks to derive critical properties for deeper insights and more support to computational improvements. Instead of following that convention, techniques of the subject invention duplicate decision variables and constraints of the lower-level problem and provide the following equivalent formulation, which will be denoted hereinafter as BiMIP_{d}.

BiMIP_{d}:Θ*=min fx+gy ⁰+hz⁰ (12)

Ax≦b.x∈ [symbol] ₊^{m}^{_{c}}× [symbol] ₊^{m}^{_{d}}, (13)

Py⁰+Nz⁰≦R−Kx,y⁰∈ [symbol] ₊ⁿ^{_{c}},z⁰∈ [symbol] ₊ⁿ^{_{d}}, (14)

wy⁰+vz⁰≧max{wy+vz:Py+Nz≦R−Kx,y∈ [symbol] ₊ⁿ^{_{c}},z∈ [symbol] ₊ⁿ^{_{d}}}, (15)

It should be noted that Equations (14-15) ensure that (y⁰, z⁰) is an optimal solution to the lower-level problem for any x. Hence, the equivalence between BiMIP_{d} and BiMIP is straightforward. Similarly to the conventional solution concept of BiMIP, let 3-tuple (x, y⁰, z⁰) represent a solution of BiMIP_{d}. Thus, an optimal solution to the lower-level problem, with respect to x, can be obtained by setting (y, z)=(y⁰, z⁰).

This type of formulation has been presented for bilevel linear programming problems to design global optimization algorithms. However, as more variables and constraints are involved, it does not appear to be an effective formulation to solve bilevel linear optimization problems. Hence, over the last 20 years, this formulation has received very limited attention.

The formulation in BiMIP_{d} is an informative, convenient, and advantageous representation for analysis and for developing computing techniques for general bilevel MIP. First, by replicating variables (and constraints), BiMIP_{d} provides a complete variable set, including the original upper-level variables x and the lower-level variables, which are now represented by (y⁰, z⁰), at the control of the upper-level DM. Conceptually, the upper-level DM will be able to use (y⁰, z⁰) to simulate the response of the lower-level DM, and to evaluate the impact of that response in the upper-level DM's decision scheme. Due to the constraint in Equation (15), it is clear that the feasible set of (x, y⁰, z⁰) is Ω^{I}, the inducible region of the complete bilevel MIP problem. It should be noted that in embodiments targeting or cases involving the structured interdiction model, such replication is not necessary.

Second, unlike BiMIP, which imposes a membership restriction on (y, z), the inequality constraint in Equation (15) on (y⁰, z⁰) is more friendly to general mathematical programming tools. Indeed, if Equation (15) is ignored, or the right-hand-side of Equation (15) is equivalently replaced by −∞, it is straightforward to see that the resulting formulation is high point problem, a weak relaxation of BiMIP_{d} or BiMIP. Naturally, strengthening the right-hand-side of Equation (15) will obtain a stronger relaxation.

Third, it should be noted that bilevel MIP with a lower-level LP can be solved by using its Karush-Kuhn-Tucker (KKT)-condition-based reformulation. Nevertheless, it has been recognized that relaxing the lower-level MIP into an LP does not yield a valid method to solve the original bilevel MIP. Through BiMIP_{d} and Equation (15), it is rather easy to identify the actual reason: given that the LP relaxation has an optimal value larger than that of original MIP problem, replacing the right-hand-side of Equation (15) by its LP relaxation will lead to a very different constraint that may cut off a large portion of the bilevel feasible set Ω^{I} and produce a poor-quality solution.

Example 1. Example 1 shows a scenario adapted from Moore et al. (The mixed integer linear bilevel programming problem, Operations Research, 38(5):911 -921, 1990; which is incorporated herein by reference) to illustrate applicability of the BiMIP_{d} reformulation and its various advantages. Consider the following bilevel MIP problem represented in the popular BiMIP form:

$${{min}_{x ∈ ℤ +} - x - 10 z}_{ } \\ z ∈ arg max \{ \begin{matrix}- z \text{:} - 25 x + 20 z \leq 30 , x + 2 z \leq 10 , \\ 2 x - z \leq 15 , 2 x + 10 z \geq 15 , z ∈ {ℤ}_{+}\end{matrix} \} . \qquad ( 16 )$$

Using certain described techniques, its corresponding BiMIP_{d} reformulation is

$${min}_{( x , {y}^{0} ) ∈ {ℤ}_{+}^{2}} - x - 10 {z}^{0} - 25 x + 20 {z}^{0} \leq 30 , x + 2 {z}^{0} \leq 10 , \\ 2 x - {z}^{0} \leq 15 , 2 x + 10 {z}^{0} \geq 15 , \\ - {z}^{0} \geq max \{ \begin{matrix}- z \text{:} - 25 x + 20 z \leq 30 , x + 2 z \leq 10 , \\ 2 x + z \leq 15 , 2 x + 10 z \geq 15 , z ∈ {ℤ}_{+}\end{matrix} \} . \qquad ( 17 )$$

For this instance, its optimal value is −22 and its unique optimal solution is (x, z)=(2, 2) for BiMIP form (or (x, z⁰)=(2, 2) in BiMIP_{d} terms).

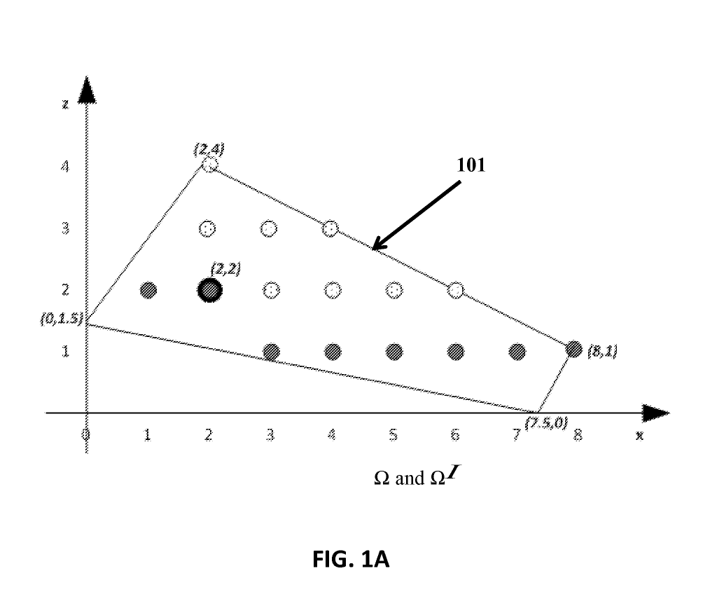

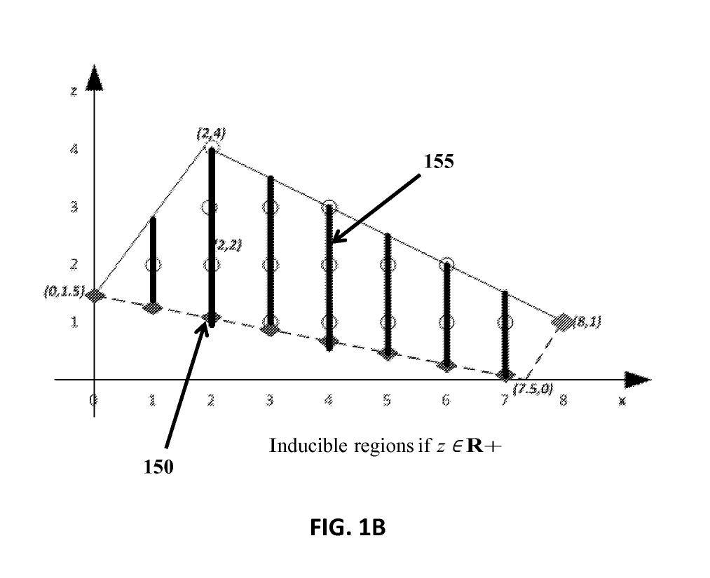

FIGS. 1A-1B show the feasible sets of problems related to Example 1. The collection of solid dots in FIG. 1A is the inducible region (also the feasible set of equation (17)) of this instance. The collection of all dots in the convex polytope 101 in FIG. 1A, including both solid and empty ones, represents the feasible set of high point problem, i.e., the set Ω. It should be noted that high point problem is equivalent to BiMIP_{d} formulation with the last constraint replaced by −z⁰≧−∞. Clearly, this high point problem is a relaxation to the bilevel MIP instance. Nevertheless, comparing its optimal value, which is −42 from (x, z)=(2, 4), to that of the bilevel MIP, indicates that this relaxation is weak.

Relaxing the lower-level variable z in Equation (16) to be continuous equivalently sets both z⁰ and z in Equation (17) to be continuous, and the resulting bilevel MIP has an inducible region which is the collection of diamond points (e.g., 150) in FIG. 1B, and produces an optimal value ˜18 from (x, z)=(8, 1). Clearly, this inducible region does not have any strong connection with respect to Ω^{I}, as their only intersection is the single point (8, 1). It should be noted that the collection of bold lines (including all diamond points) (e.g., 155), which is the feasible set of (x, z⁰) without considering the optimality constraint between z⁰ and z in equation (17), contains Ω^{I} as its subset. Nevertheless, if that optimality constraint between z⁰ and z is imposed, because a larger optimal value serves as its right-hand-side, it cuts off most part of that collection, including Ω^{I}, and just leaves diamond points as feasible points.

Various embodiments may include additional reformulations and strong relaxations of BiMIP_{d}, to which additional techniques (e.g., decomposition) may be applied. Certain of these embodiments are explored below.

Expanded Single-Level Formulation

In one embodiment, a single-level equivalent reformulation of BiMIP_{d}, may be obtained by expanding Equation (15) using enumeration. This reformulation technique assumes that, for any possible (x, z), the remaining lower-level problem has a finite optimal value. Herein, this assumption is referred to as the relatively complete response property because of its similarity to the relatively complete recourse property, a frequently used concept in stochastic programming literature to ensure the feasibility of the recourse problem under any feasible choice of the first stage decision.

First, discrete and continuous variables are separated in the lower-level to restructure the right-hand-side of Equation (15) as follows:

$${wy}^{0} + {vz}^{0} \geq {max}_{z ∈ Z} vz + max \{ wy \text{:} Py \leq R - Kx - Nz , y ∈ {ℝ}_{+}^{{n}_{c}} \} \qquad ( 18 )$$

where Z represents the collection of all possible z. This reformulation technique is counterintuitive because replacing Equation (15) by Equation (18) turns BiMIP_{d} into an even more difficult trilevel formulation. However, since the second maximization problem in Equation (18) is a pure LP, the classical reformulation method using KKT conditions can be applied. Thus, the equivalent form becomes:

$${wy}_{0} + {vz}_{0} \geq {max}_{z ∈ Z} vz + wy$$

$$s . t . ( y , π ) ∈ \{ \begin{matrix}Py \leq R - Kx - Nz , {P}^{t} π \geq {w}^{t} , \\ y ⊥ ( {P}^{t} π - {w}^{t} ) , π ⊥ ( R - Kx - Nz - Py )\end{matrix} \} .$$

Unless otherwise noted, it is assumed that Z is a finite set such that Z={z¹, . . . , z^{k}}. In most computational scenarios, this assumption is relatively unrestrictive. Note that if some components of z can take very large values, they can in some cases be treated as continuous variables rather than discrete variables. Given this assumption, by enumerating z^{j} and introducing corresponding variables (y^{j}, π^{j}), BiMIP_{d} in Equations (12-15) may be reformulated as below, hereinafter called the “expanded single-level formulation”:

Σ_{Z}:min fx+gy⁰+hz⁰ (19)

s.t.(13-14) (20)

wy⁰+vz⁰≧vz^{j}+wy^{j},1≦j≦k (21)

Py^{j}≦R−Kx−Nz^{j},P^{t}π^{j}≧w^{t},1≦j≦k (22)

y^{j}⊥(P^{t}π^{j}−w^{t}),π^{j}⊥(R−Kx−Nz^{j}−Py^{j}),1≦j≦k (23)

y^{j}∈ [symbol] ₊ⁿ^{_{c}},π^{j}∈ [symbol] ₊ⁿ^{_{c}},1≦j≦k. (24)

Several additional characteristics may be derived from the expanded single-level formulation. First, the aforementioned equivalent reformulation Σ_{z} is a mathematical program with complementarity constraints. It can be easily converted into a regular MIP using the linearization technique presented in Equation (8), which further enables solution using popular MIP solvers. Or, it can be directly computed by using Branching-and-Bound techniques on complementarity constraints. Various methods [47, 31, 41, 29] may exist for problems with complementarity constraints; however, most are effective only with continuous problems.

Second, for some bilevel MIP problems, if the upper-level problem is an MIP and its lower-level problem includes discrete variables, it may not be possible to achieve its infimum, for which min would be replaced by inf in Equations (1) and (12). Although the disclosed techniques are for those problems with optimal solutions, the relatively complete response property provides a sufficient condition to ensure the existence of an optimal solution.

Furthermore, the following corollary follows when a bilevel MIP problem has the relatively complete response property:

Corollary 3. If a bilevel MIP problem has the relatively complete response property, its optimal solutions exist, which can be obtained by branching on complementarity constraints of Σ_{Z}.

Corollary 3 is similar to the Benders Reformulation and Dantzig-Wolfe Reformulation. However, this equivalent reformulation (or its MIP counterpart) can be extremely large, meaning that its practical significance is limited.

In some embodiments, a subset of the constraints, as shown in Corollary 4, may be of more value as a technique for solving bilevel MIP.

Corollary 4. Let Z be a subset of Z. A partial reformulation constructed with respect to Z, which is denoted by Σ_{Z}, is a relaxation and provides a lower bound to BiMIP_{d}. In particular, it is stronger than high point problem by strengthening the right-hand-side of Equation (15) using KKT conditions.

Notably, it is possible to obtain a stronger relaxation and better lower bound by considering a larger Z and computing the corresponding Σ_{Z}. A decomposition technique to dynamically expand Z is described below.

An Extended Formulation

For a bilevel MIP problem that does not have the relatively complete response property, there exists some (x, z) tuple such that the remaining lower-level linear program is infeasible. For such a situation, additional variables \tilde{y}=(\tilde{y}₁, . . . , \tilde{y}ₙ₁) with big-M penalty coefficients can be introduced to compensate constraint violations. Specifically, it is possible to replace Equation (15) in BiMIP_{d} with the following constraint where I is the identity matrix:

$${wy}^{0} + {vz}^{0} \geq {max}_{ } \{ \begin{matrix}wy + vz - M {\sum }_{i} {\tilde{y}}_{i} \text{:} Py + Nz \leq R - Kx + I \tilde{y} , \\ ( y , \tilde{y} ) ∈ {ℝ}_{+}^{{n}_{c} + {n}_{1}} , z ∈ {ℤ}_{+}^{{n}_{d}}\end{matrix} \} \qquad ( 25 )$$

The formulation BiMIP_{d} with Constraint (15) replaced by Constraint (25) is referred to hereinafter as the “extended formulation” of the original one. The characteristics of the extended formulation are summarized as Proposition 5, below:

Proposition 5. (i) The extended formulation has the relatively complete response property. (ii) Assume M is sufficiently large. The extended formulation is a relaxation of the original formulation in Equations (12-15). Moreover, there exists an optimal solution to the extended formulation that is also feasible and optimal to the original one.

In order to prove the second statement, i.e., that the extended BiMIP_{d} formulation with Equation (15) replaced by Equation (25) is a relaxation to the original one, it is sufficient to show that if (x, y⁰, z⁰) is in the inducible region, i.e., is feasible to the original formulation, it is also feasible to the extended one.

To prove the second statement, for this x, let ((y*, \tilde{y}*), z*) denote an optimal solution to the lower-level problem of the extended formulation as in the right-hand-side of Equation (25). Also, it is evident that ((y⁰, z⁰) is feasible to the same problem. By contradiction, assume that:

$${wy}^{*} + {vz}^{*} - M {\sum }_{i} {\tilde{y}}_{i}^{*} > {wy}^{0} + {vz}^{0} - M {\sum }_{i} 0 = {wy}^{0} + {vz}^{0} . \qquad ( 26 )$$

Nevertheless, because M is sufficiently large, unless \tilde{y}*=0, Equation (26) will not be valid. When \tilde{y}*=0, (y*, z*) is feasible to the lower-level problem of the original formulation, which, according to Equation (26), is better than (y⁰, z⁰) Hence, in either case, there is a contradiction. Therefore, it is conclusive that ((y⁰, z⁰) is an optimal solution to the lower-level problem of the extended formulation. Because Equation (25) is satisfied, (x, y⁰, z⁰) is feasible to the extended formulation.

Furthermore, for any given x, it is valid for any M that

$$max \{ \begin{matrix}wy + vz - M {\sum }_{i} {\tilde{y}}_{i} \text{:} Py + Nz \leq R - Kx + I \tilde{y} , \\ ( y , \tilde{y} ) ∈ {ℝ}_{+}^{{n}_{c} + {n}_{1}} , z ∈ {ℤ}_{+}^{{n}_{d}}\end{matrix} \} \\ max \{ wy + vz \text{:} Py + Nz \leq R - Kx , y ∈ {ℝ}_{+}^{{n}_{c}} , z ∈ {ℤ}_{+}^{{n}_{d}} \} . \qquad ( 27 )$$

So, for an optimal solution of the extended formulation, it must satisfy Equation (15) of the original formulation, which ensures its feasibility. Because the extended formulation is a relaxation to the original one, its optimality follows.

Advantageously, embodiments including the extended formulation can provide a practical strategy to handle instances where a given problem does not have the relatively complete response property. Nevertheless, according to Corollary 3, if bilevel MIP does not have any optimal solution, it can be inferred that there is no finite big-M to ensure validity of the second statement of Proposition 5.

Example 2. Example 2 shows a scenario adapted from Köppe et al. (Parametric integer programming algorithm for bilevel mixed integer programs, Journal of Optimization Theory and Applications, 146(1):137-150, 2010; which is incorporated herein by reference) to illustrate applicability of the extended formulation and its various advantages.

In the bilevel MIP problem:

inf x−z (28)

s.t.0≦x≦1,z∈arg max{−z,x−z≦−z,x∈{0,1}}. (29)

Its extended formulation is

min x−z⁰

s.t.0≦x≦1,−z⁰≦−x,z⁰∈{0,1}

−z⁰≧max{−z−M\tilde{y}:−z≦−x+\tilde{y},z∈{0,1},\tilde{y}≧0}.

Since this extended formulation has the relatively complete response property, the original bilevel MIP in Equations (28-29) is equivalent to the following expanded single-level formulation Σ_{z} with Z={0, 1}:

Σ_{Z}:min x−z⁰

s.t.0≦x≦1,−z⁰≦−x

−z⁰≧0−M\tilde{y}¹, \tilde{y}¹≧x,π¹≧−M,\tilde{y}¹⊥(π¹+M),π¹⊥(\tilde{y}¹−x)

−z⁰≧−1−M\tilde{y}², \tilde{y}²≧x−1,π²≧−M,\tilde{y}²⊥(π²+M),π²⊥(\tilde{y}²−x+1)

z⁰∈{0,1},\tilde{y}¹≧0,\tilde{y}²≧0,π¹24 0,π²≧0

where π¹ and π² are dual variables for the constraint of the lower-level problem for z=0 and 1, respectively.

This formulation can be solved numerically for any fixed M. Indeed, it can be analytically derived that there exists an optimal solution with (x, z⁰, \tilde{y}¹, \tilde{y}², π¹, π²)=(1/M, 1, 1/M, 0, −M, 0) and the optimal value is 1/m−1.

According to Köppe et al. (supra.), the original bilevel MIP does not have an optimal solution and the infimum of the objective function value is −1. The extended formulation can be used to derive ε-optimal solutions by adjusting the value of M.

Strong-Duality-Based Formulation

In some embodiments, an alternative reformulation to the single-level reformulation can be obtained by employing the strong duality theorem of linear programming. The “strong-duality-based formulation” of BiMIP_{d} can be formed by rewriting the right-hand-side of Equation (18) by strong duality as follows:

$${wy}_{ }^{0} + {vz}^{0} \geq {max vz}_{z ∈ Z} + min \{ {( R - Kx - Nz )}^{t} π \text{:} {P}^{t} π \geq {w}^{t} \text{:} π ∈ {ℝ}_{+}^{{n}_{1}} \} .$$

Removing the min operator obtains the next variation:

$${wy}_{ }^{0} + {vz}^{0} \geq {max vz}_{z ∈ Z} + \{ {( R - Kx - Nz )}^{t} π \text{:} {P}^{t} π \geq {w}^{t} \text{:} π ∈ {ℝ}_{+}^{{n}_{1}} \} .$$

Then, an equivalent formulation, similar to that of Theorem 2, follows easily. Theorem 6, below, describes the strong-duality-based reformulation.

Theorem 6. The formulation BiMIP_{d} in equations (12-15) is equivalent to its expanded single level formulation:

Σ_{Z}^{d}:min fx+gy⁰+hz⁰ (30)

s.t.(13-14) (31 )

wy⁰+vz⁰≧vz^{j}+(R−Kx−Nz^{j})^{t}π^{j},1≦j≦k (32)

P^{t}π^{j}≧w^{t},1≦j≦k (33)

π^{j}∈ [symbol] ₊ⁿ^{₁};1≦j≦k. (34)

With respect to Theorem 6, π^{j} variables for all j are defined by a set of same constraints: {P^{t}π≧w^{t}, π∈ [symbol] ₊ⁿ^{ᵢ}}. Given that a finite optimal solution to BiMIP exists, which indicates a particular optimal primal and dual pair (y^{j}, π^{j}) exists, the dual feasible set defined by the aforementioned constraints is never empty. Hence, this strong duality-based reformulation does not depend on any additional assumptions or property, which is less restrictive than the reformulation based on KKT conditions. This reveals an essential logic implied in BiMIP_{d}. Following from the non-empty dual feasible set that, for fixed (x, z), the lower-level problem is either finitely optimal or infeasible. If the first case occurs, as shown in Equation (32), a non-trivial lower bound, which is parameterized by x, will be available. Otherwise, that lower-bound will become trivial as the right-hand-side of Equation (32) may be equal to −∞.

Example 2.1. In order to make use of strong duality for the lower-level problem, the bilevel formulation in Example 2 is augmented in Example 2.1 by introducing a continuous variable y as follows:

inf x−z

s.t.0≦x≦1

z∈arg max{−z+0y:−z−y≦−x,y≦0,y≧0,z∈{0,1}}.

Constraints on y simply force it to be 0. Given Z={0, 1}, its single-level equivalent formulation through strong duality is:

inf x−z⁰ (35)

s.t.0≦x≦1,−z⁰≦−x⁰,y⁰≦0,y⁰≧0,z⁰∈{0,1} (36)

−z⁰≧0−π¹¹x,−π¹¹+π¹²≧0,π¹¹,π¹²≧0 (37)

−z⁰≧−1+π²¹(1−x),−π²¹+π²²24 0,π²¹,π²²≧0 (38)
where π¹¹ and π¹² are dual variables for the first and second constraint of the lower-level problem for z=0. Similarly, π²¹ and π²² are introduced as dual variables for z=1.

From Equation (37), it can be seen that when x>0, the right-hand-side could be −∞, given that π¹¹ can be positively unbounded. So, this constraint is trivial. At the same time, from Equation (38), given x≦1 and π²¹≧0, it can be seen that the inequality can reduce to −z⁰≧−1. Hence, both Equation (37) and Equation (38) can be trivial, all constraints on dual variables can be removed, and the whole formulation behaves like high point problem. Nevertheless, when x=0, the situation is different. Constraint (37) becomes −z⁰≧0 (and Equation (38) can still be trivial), which, together with a nonnegativity constraint, leads to z⁰=0.

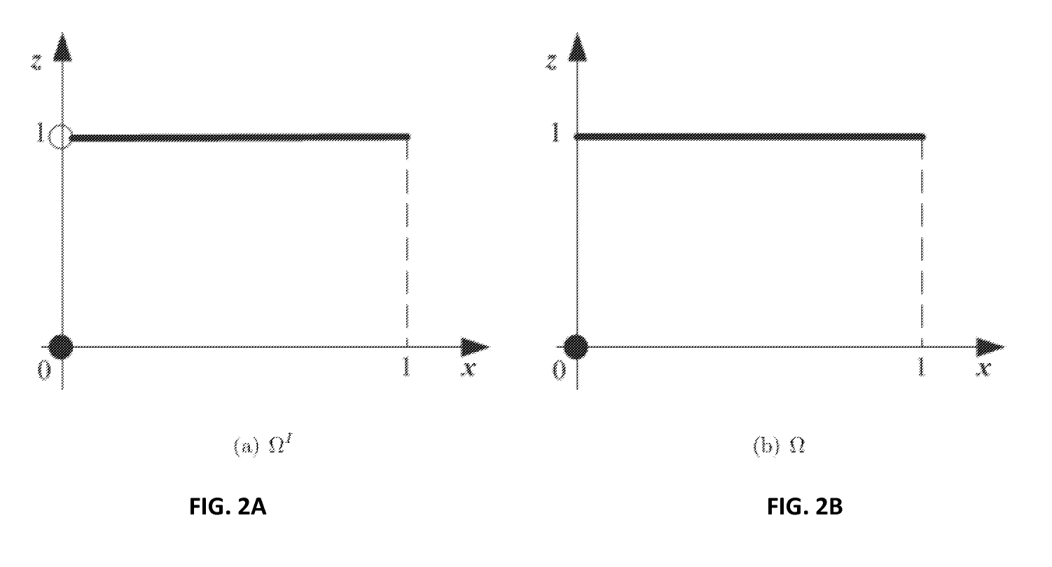

FIGS. 2A-2B show the feasible set of (x, z⁰)). FIG. 2A shows the inducible region Ω^{I} of the original bilevel MIP, and FIG. 2B shows the feasible region Ω of the corresponding high point problem. It should be noted that Ω^{I} does not include point (0, 1), and it is actually a union of {(0, 0)} and {(0, 1]×{1}}. Without that point, such union is not closed. On the contrary, Ω includes point (0, 1) and becomes closed and bounded, which allows high point problem to achieve its optimal value. If all dual variables are bounded by M in this single-level equivalent formulation, it can be derived that an optimal solution can be obtained by setting (x, z⁰)=(1/M, 1) with the optimal value 1/M−1, which is also same as those from the extended formulation.

Furthermore, comparing π_{Z}^{d} and the KKT-conditions-based Σ_{z} in Theorem 2, it is clear that Σ_{Z}^{d} is of a simpler structure with less variables and constraints. Nevertheless, bilinear terms between x and π^{j} in constraint (32) render Σ_{Z}^{d} (and its relaxation defined with respect to subset Z) a challenging mixed integer nonlinear program. It probably is less friendly than Σ_{Z}^{d} to practitioners, as the latter one can be easily linearized into an MIP model. For an instance where x are binary variables, products between x and π^{j} can also be linearized and its Σ_{Z}^{d} formulation can be converted into an MIP problem, which could lead to better computational performance than its KKT-based one [2].

In embodiments using the interdiction model presented in Equation (9), it is also possible to derive alternative equivalent reformulations that are simpler than Σ_{z}. Specifically, because the upper and lower-level DM have completely opposite objective functions, it is possible to minimize the largest possible objective function value of the lower-level problem, without introducing (y⁰, z⁰) variables and related constraints.

Corollary 7, below, presents the equivalent single-level reformulation based on KKT conditions for an interdiction problem. The reformulation based on strong duality can be derived similarly.

Corollary 7. The interdiction model in Equation (9) is equivalent to its expanded single level formulation

Σ_{Z}^{I}:min{η:η≦vz^{j}+wy^{j},1≦j≦k, (22-24 )}.

As presented in Corollary 4, for any aforementioned single-level equivalent formulation, a partial reformulation constructed with respect to a subset Z leads to a strong relaxation of BiMIP_{d}.

Solving Bilevel MIP Problems by Decomposition

The single-level equivalent formulation, the strong relaxations and the associated lower bounds, provide a basis for a dynamic solution technique for BiMIP_{d}. In particular, by expanding Z and Σ_{Z}, a tighter relaxation and a stronger lower bound will be available; this, in turn, may also help to target a better feasible solution and a smaller upper bound for BiMIP_{d}. In the example embodiments described, Σ_{z} (and its relaxations) is the platform to describe the technique implementation, though the technique strategy works equally well for alternative reformulations Σ_{Z}^{d} and Σ_{Z}^{I}.

Certain embodiments of the subject invention use a master-subproblem technique for computing a solution to BiMIP_{d}. This technique may be referred to herein as “decomposition.”

In an embodiment, consider a given (upper-level) solution x*. By solving the subproblem, which is the lower-level problem, an optimal (y*, z*) can be derived. As (x*, y*, z*) is a feasible solution, its value, fx*+gy*+hz*, provides an upper bound to BiMIP_{d}. Then, the set Z is updated to include z* and the master problem Σ_{Z} is expanded. Solving the master problem again leads to a new x*, as well as a stronger lower bound, for a new iteration. By iteratively solving the master and subproblems, lower and upper bounds converge to the optimal value.

An embodiment implementing the described decomposition techniques can include the following:

Let UB and LB be the upper and lower bounds respectively, let/be the iteration index and let ε be the optimality tolerance.

Step 1. Set LB=−∞, UB=+∞, and l=0.

Step 2. Solve the following master problem

MP:Θ*=min fx+gy⁰+hz⁰ (39)

s.t.(13-14)

wy⁰+vz⁰≧vz^{j}+wy^{j},1≦j≦l (40)

Py^{j}≦R−Kx−Nz^{j},P^{t}π^{j}≧w^{t},1≦j≦l (41)

y^{j}⊥(P^{t}π^{j}−w^{t}),π^{j}⊥(R−Kx−Nz^{j}−Py^{j}),1≦j≦l (42)

y^{j}∈ [symbol] ₊ⁿ^{_{c}},π^{j}∈ [symbol] ₊ⁿ^{₁},1≦j≦l (43)

Derive an optimal solution (x*, y⁰*, z⁰*, y¹*, . . . , y^{l}*, π¹*, . . . , π^{l}*), and update LB=⊖*.

Step 3: If UB−LB ≦ε, return UB and the corresponding (incumbent) solution. Terminate. Otherwise, go to Step 4.

Step 4: Solve the following lower-level problem for given x*, which serves as the first subproblem.

θ(x*)=max {wy+vz: Py+Nz≦R−Kx*, y ∈ [symbol] ₊ⁿ^{_{c}}, z ∈ [symbol] ₊ⁿ^{_{d}}}.
Then, compute the next one, which is the second subproblem.

⊖_{ƒ}(x*)=min {gy+hz: wy+vz≧θ(x*), Py+Nz≦Kx*, y − [symbol] ₊ⁿ^{_{c}}, z ∈ [symbol] ₊ⁿ^{_{d}}}.
Derive an optimal solution (y*, z*), and update UB=min {UB, fx*+⊖_{ƒ}(x*)}.

Step 5: Set z^{l+1}=z*, create variables (y^{l+1}, π^{l+1}), and add the following constraints to MP:

wy⁰+vz⁰≧vz^{l+1}+wy^{l+1},

Py^{l+1}≦R−Kx−Nz^{l+1}, P^{t}π^{l+1}≧w^{t},

y^{l+1}⊥(P^{t}π^{l+1}−w^{t}), π^{l+1}⊥(R−Kx−Nz^{l+1}−Py^{l+1}),

y^{l+1}∈ [symbol] ₊ⁿ^{_{c}}, π^{l+1}∈ [symbol] ₊ⁿ^{₁}

Step 6: Set l=l+1, and go to Step 2.

Note that the lower-level problem may have multiple optimal solutions for x*. By computing the second subproblem, which is constructed by the lexicographic method, it will be possible to select an optimal solution that is in favor of the upper-level DM, a reflection of the optimistic consideration. Solving the second subproblem in Step 4 is generally beneficial. Nevertheless, for structured interdiction problems or formulations in the form of Equation (11), because upper-level and lower-level DMs are of opposite interest, computing the second subproblem is not needed.

Embodiments implementing the decomposition techniques may be used to converge on an optimal solution of BiMIP_{d} within O(|Z|) iterations, assuming that Z is finite, and assuming ε=0.

By way of proof, it is sufficient to show that a repeated z* leads to LB=UB. Assume that the current iteration index is l₁, (x*, y⁰*, z⁰*) is obtained in Step 2 with LB<UB, and z* is obtained in Step 4. Further assume that z* was derived in some previous iteration l₀(<l₁).

Because UB−LB>0, as in Step 5, MP will be augmented with a set of new variables and constraints associated with z* (=z^{l}^{₁}⁺¹). Nevertheless, as those variables and constraints are the same as those created and included in iteration l₀, the augmentation essentially does not change MP. So, it yields the same optimal value in iteration l₁+1 as that of iteration l₁. Hence, LB does not change when the algorithm proceeds from iteration l₁ to l₁+1.

Now it can be shown that LB≧UB in iteration l₁+1. Note that z^{l}^{₁}⁺¹=z*.

$$\begin{matrix}LB = {fx}^{*} + {gy}^{0 *} + {hz}^{0 *} \\ = {fx}^{*} + min \{ {gy}^{0} + {hz}^{0} \text{:} ( 13 - 14 ) , ( 40 - 43 ) , x = {x}^{*} \} \geq \\ {fx}^{*} + min \{ {gy}^{0} + {hz}^{0} \text{:} {Py}^{0} + {Nz}^{0} \leq R - {Kx}^{*} , {wy}^{0} + {vz}^{0} \geq \\ {vz}^{{l}_{1} + 1} + {wy}^{{l}_{1} + 1} , {Py}^{{l}_{1} + 1} \leq R - {Kx}^{*} - {Nz}^{{l}_{1} + 1} , \\ {P}^{t} {π}^{{l}_{1} + 1} \geq {w}^{t} , {y}^{{l}_{1} + 1} ⊥ ( {P}^{t} {π}^{{l}_{1} + 1} - {w}^{t} ) , {π}^{{l}_{1} + 1} ⊥ ( R - {Kx}^{*} - \\ {Nz}^{{l}_{1} + 1} - {Py}^{{l}_{1} + 1} ) , {z}^{0} ∈ {ℤ}_{+}^{{n}_{d}} , {y}^{0} , {y}^{{l}_{1} + 1} ∈ {ℝ}_{+}^{{n}_{c}} , {π}^{{l}_{1} + 1} ∈ {ℝ}_{+}^{{n}_{1}} \} \leq \\ {fx}^{*} + min \{ {gy}^{0} + {hz}^{0} \text{:} {Py}^{0} + {Nz}^{0} \leq R - {Kx}^{*} , {wy}^{0} + {vz}^{0} \geq \\ θ ( {x}^{*} ) , {y}^{0} ∈ {ℝ}_{+}^{{n}_{c}} , {z}^{0} ∈ {ℤ}_{+}^{{n}_{d}} \} \\ = {fx}^{*} + {Θ}_{f} ( {x}^{*} )\end{matrix}$$

The second inequality follows from the fact that z^{l}^{₁}⁺¹ is optimal to θ(x*) and constraints from KKT conditions ensure that vz^{l}^{₁}⁺¹+wy₁^{l+1}=θ(x*). Then, in Step 3, LB≧UB, which terminates the processing loop.

An implementation of the techniques does not depend on the cardinality of Z, which could be infinite. Provided that a finite optimal solution exists, processing will converge on an optimal solution though finite iterations. Indeed, as shown below in the computational results, the techniques may lead to an optimal solution within a small number of iterations, which could be drastically less than the cardinality of Z. In addition to the convergence and computational complexity, the techniques, including single-level equivalent formulations, have several advantages over existing methods.

First, the basis of the decomposition technique is the single-level equivalent formulations. These formulations involve KKT conditions (and strong duality) and an enumeration of possible discrete values. Reformulating a problem in these terms does not require subjective design or customization, and thus techniques provide a fundamental platform to solve bilevel MIP problems.

Second, the complete decomposition algorithm is easy to implement. Again, master problem MP is an MIP with complementarity constraints, which can be converted into a regular MIP by the technique in Equation (8). Hence, both master problem and subproblem can basically be computed by any popular MIP solver, which is conveniently accessible to many researchers and practitioners to compute practical instances.

Third, the decomposition technique is an open and flexible framework that supports further improvements. For example, domain knowledge may be used to develop fast heuristic procedures for better upper bounds, or take advantage of non-trivial z identified by those heuristics to derive better lower bounds and therefore to reduce the necessary iteration. Also, one bottleneck of this method is to solve master problem MP, which grows with iterations and demonstrates a dual block angular structure (with complementarity constraints). Hence, instead of using existing solvers, it may be beneficial to develop customized algorithms to make use of such structure for fast computing.

In some embodiments, a computationally efficient enhancement technique may be used to strengthen master problem MP. To illustrate, consider “Proposition 9.”

Proposition 9. Let ŷ and \hat{π} represent the primal and dual variables of the lower-level LP corresponding to (x, z⁰. The master problem MP in Step 2 above can be augmented as the following MP_{aug} problem:

MP_{aug}:Θ*=min fx+gy⁰+hz⁰ (45)

s.t. (13-14), (40,43)

wy⁰+vz⁰≧vz⁰+wŷ (46)

Pŷ≦R−Kx−Nz⁰,P^{t}π≧w^{t} (47)

ŷ⊥(P^{l}π−w^{t}),\hat{π}⊥(R−Kx−Nz⁰−Pŷ) (48)

ŷ∈ [symbol] ₊ⁿ,\hat{π}∈ [symbol] ₊ⁿ^{₁}, (49)

MP_{aug} has a larger optimal value and therefore produces a stronger lower bound than MP. This formulation may be referred to herein as the “augmented formulation” of the master problem.

Given that both x and z⁰ are variables, MP_{aug} includes some lower bound information that is parametric not only to x but also to z⁰. As shown in Equation (46), although z⁰ might not reflect the optimal response from the lower-level DM towards x, it provides, through ŷ and \hat{π}, an effective lower bound support to wy⁰+vz⁰ which might not be available from a fixed z¹, . . . , z¹. In the computational studies below, the benefit of this enhancement strategy is shown to be significant. However, it should be noted that, without continuous variables in its lower-level problem, the usefulness of this enhancement strategy is diminished, since the artificial continuous variables in its extended formulation are penalized with big-M to remove its impact.

Example 1.1. Example 1.1 illustrates the proposed techniques by continuing Example 1.

To make the bilevel MIP formulation in equation (17) with the relatively complete response property, continuous variables (ŷ₁, ŷ₂, ŷ₃, , ŷ₄) are introduced as in Equation (25) for constraints in the lower-level problem:

$${min}_{( x , {y}^{0} ) ∈ {ℤ}_{+}^{2}} - x - 10 {z}^{0} - 25 x + 20 {z}^{0} \leq 30 , x + 2 {z}^{0} \leq 10 , \\ 2 x - {z}^{0} \leq 15 , 2 x + 10 {z}^{0} \geq 15 , - {z}^{0}$$

$$max \{ \begin{matrix}- z - M {\sum }_{i = 1}^{4} {\tilde{y}}_{i} \text{:} - 25 x + 20 z \leq 30 + {\tilde{y}}_{1} , \\ x + 2 z \leq 10 + {\tilde{y}}_{2} , 2 x - z \leq 15 + {\tilde{y}}_{3} , 2 x + 10 z \geq 15 + {\tilde{y}}_{4} , \\ x ∈ {ℤ}_{+}^{ } , {\tilde{y}}_{i} ∈ {ℝ}_{+}^{ } , i = 1 , ⋯ , 4\end{matrix} \} .$$

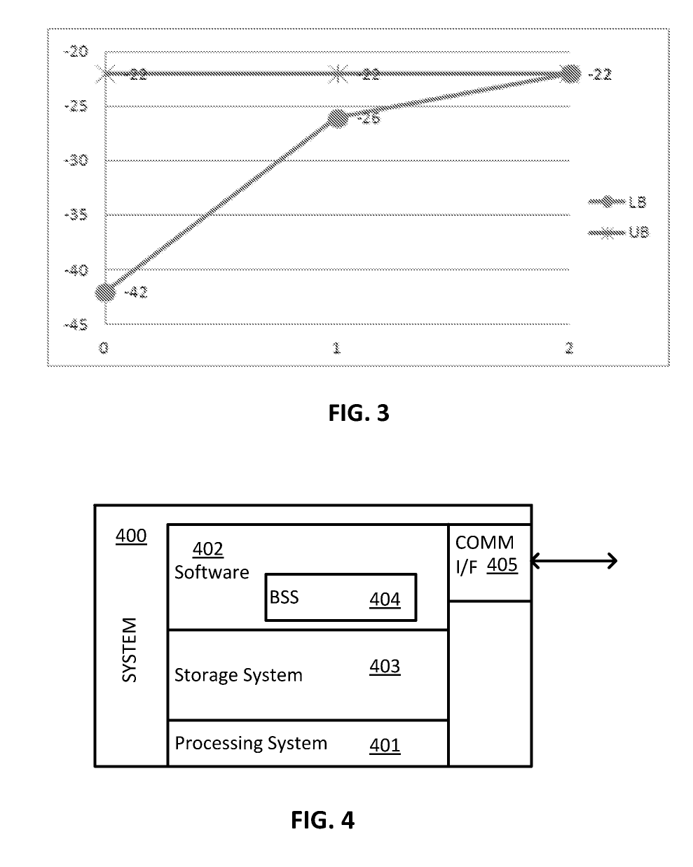

Progress over several iterations of the decomposition techniques is shown below. Big M is set to 10,000. FIG. 3 shows plotted bound information from iterations 0-2.

iteration l=0: Solving MP, which actually is high point problem, yields (x*, z⁰*)=(2, 4), and LB=−42. Given x=2, solving the subproblems results in z*=2 and UB=−22.

iteration l=1: Solving MP, (x*, z⁰*)=(6, 2), and LB=−26. Given x=6, solving the subproblems results in z*=1 and UB=min {−22, −16}=−22.

iteration l=2: Solving MP, (x*, z⁰*)=(2, 2) and LB=−22. Because LB=UB, it terminates with an optimal solution (x*, z*)=(2, 2), which is optimal to the
original bilevel MIP problem in Equation (16) (and its equivalence (17)).

FIG. 4 shows a block diagram illustrating components of a computing device or system used in some implementations or embodiments of a Bilevel MIP solution service, Bilevel MIP solution API, or a service, application, or API specific to a problem domain (e.g., a network interdiction problem). For example, any computing device operative to run a Bilevel MIP solution service or intermediate devices facilitating interaction between other devices in the environment may each be implemented as described with respect to system 400, which can itself include one or more computing devices. The system 400 can include one or more blade server devices, standalone server devices, personal computers, routers, hubs, switches, bridges, firewall devices, intrusion detection devices, mainframe computers, network-attached storage devices, and other types of computing devices. The hardware can be configured according to any suitable computer architectures such as a Symmetric Multi-Processing (SMP) architecture or a Non-Uniform Memory Access (NUMA) architecture.

An API is generally a set of programming instructions and standards for enabling two or more applications to communicate with each other. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API and related components may be stored in one or more computer readable storage media. An API is commonly implemented as a set of Hypertext Transfer Protocol (HTTP) request messages and a specified format or structure for response messages according to a REST (Representational state transfer) or SOAP (Simple Object Access Protocol) architecture.

The system 400 can include a processing system 401, which may include a processing device such as a central processing unit (CPU) or microprocessor and other circuitry that retrieves and executes software 402 from storage system 403. Processing system 401 may be implemented within a single processing device but may also be distributed across multiple processing devices or sub-systems that cooperate in executing program instructions.

Examples of processing system 401 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 403 may comprise any computer readable storage media readable by processing system 401 and capable of storing software 402 including, e.g., a Bilevel MIP solution service, application software for solving general or domain-specific Bilevel MIP problems, or an API for solving Bilevel MIP problems that is accessible to one or more other application software packages. Storage system 403 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic disks, optical disks, CDs, DVDs, flash memory, solid state memory, phase change memory, or any other suitable storage media. Certain implementations may involve either or both virtual memory and non-virtual memory. In no case do storage media consist of a propagated signal. In addition to storage media, in some implementations, storage system 403 may also include communication media over which software 402 may be communicated internally or externally.

Storage system 403 may be implemented as a single storage device but may also be implemented across multiple storage devices or sub-systems co-located or distributed relative to each other. Storage system 403 may include additional elements, such as a controller, capable of communicating with processing system 401.

Software 402 may be implemented in program instructions and, among other functions, may, when executed by system 400 in general or processing system 401 in particular, direct system 400 or processing system 401 to operate as described herein for reformulating and solving a BiMIP problem. Software 402 may provide program instructions 404 that implement a BiMIP solution application, BiMIP solution service, and/or BiMIP solution API. Software 402 may implement on system 400 components, programs, agents, or layers that implement in machine-readable processing instructions the methods described herein as performed by a BiMIP solution application, BiMIP solution service, and/or BiMIP solution API (as instructions 404).

Software 402 may also include additional processes, programs, or components, such as operating system software and other application software. For instance, other application software might include software packages for solving mathematical equations or problems that can be optimized or improved by requesting solution services from a BiMIP solution service or software layer implementing the described techniques. The application software may call the BiMIP software layer or service via an API, as described. For example, such application software might send BiMIP problems, including problem constraints, to a BiMIP solution service (perhaps hosted on a remote system and accessible over a RESTful interface), then receive in response from the BiMIP solution service the optimal solution and/or upper and lower bounds of the problem.

In general, software 402 may, when loaded into processing system 401 and executed, transform system 400 overall from a general-purpose computing system into a special-purpose computing system customized to solve a BiMIP problem. Indeed, encoding software 402 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage. Software 402 may also include firmware or some other form of machine-readable processing instructions executable by processing system 401.

System 400 may represent any computing system on which software 402 may be staged and from where software 402 may be distributed, transported, downloaded, or otherwise provided to yet another computing system for deployment and execution, or yet additional distribution.

In embodiments where the system 400 includes multiple computing devices, one or more communications networks may be used to facilitate communication among the computing devices. For example, the one or more communications networks can include a local, wide area, or ad hoc network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 405 may be included, providing communication connections and devices that allow for communication between system 400 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

It should be noted that many elements of system 400 may be included in a system-on-a-chip (SoC) device. These elements may include, but are not limited to, the processing system 401, a communications interface 405, and even elements of the storage system 403 and software 402.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Following are examples that illustrate procedures for practicing certain disclosed techniques. These examples should not be construed as limiting.

### EXAMPLE 1

A computational study was conducted to show/compare the effectiveness of certain techniques of the subject invention. The study evaluates random bilevel MIP instances. The computational study is made through C++ on a PC desktop (with a single processor at 3 GHz and 3.25 Gb memory) in accordance with system 400. The optimality tolerance of the master problem was set to 0.5%, and those of subproblems to 0.1%, and the computational time limit to 3,600 seconds.

Random instances were generated according to following specifications: (1) All instances have 20 integer variables in total. Those integer variables are split for the upper-level DM and the lower-level DM using two combinations, i.e., 15+5 and 10+10.

(2) Three types of instances are included: a) Upper-level variables, i.e., x, are binary. The lower-level problem has 5 continuous variables. b) Upper-level variables are nonnegative integer variables (bounded by 30). The lower-level problem has 5 continuous variables. c) Upper-level variables are nonnegative integer variables (bounded by 30). The lower-level problem has no continuous variables.

(3) Two objective functions are introduced--one for the upper-level DM, and one for the lower-level DM, where the latter one only involves lower-level variables.

(4) As in [37, 22], the lower-level DM is subject to all constraints. Three different sizes are considered: 10, 20 or 30 constraints respectively. Coefficients are randomly chosen in the range of [−50, 50] with 50% density.

(5) To ensure the relatively complete response property of the lower-level problem, each constraint is associated with an artificial variable whose big-M penalty coefficient is set to 10,000.

Overall, there are 18 different combinations. For each of them, 10 instances are randomly generated, with 18×10=180 instances in total. They are then computed according to an embodiment of the decomposition techniques described herein. The enhancement techniques described in Proposition 9 are adopted, except in instances where pure IP exists in the lower-level. For instances where x is binary, the strong duality based reformulation is employed in the decomposition technique. These techniques can lead to a reduction in computational time over the standard implementation. Indeed, for the difficult instances that demand a larger number of iterations in the standard implementation, the enhancement technique of Proposition 9 can reduce iterations and computational time by up to 90%. The overall computational results, which are averages of 10 random instances of every combination, are reported in Table 1.

TABLE 1
Numerical Study on General Instances

| Type | # of Const. | # Int. Var.(up) | # Int. Var.(low) | Iter. | Time (s) | Gap (%) |
|---|---|---|---|---|---|---|
| | | 15 | 5 | 2.3 | 4.19 | |
| | 10 | 10 | 10 | 2.8 | 9.92 | |
| | | 15 | 5 | 2.3 | 4.07 | |
| Bilevel (×Binary) MIP | 20 | 10 | 10 | 2.5 | 5.68 | |
| | | 15 | 5 | 2.2 | 13.25 | |
| | 30 | 10 | 10 | 2.5 | 15.14 | |
| | | 15 | 5 | 2.2 | 2.68 | |
| | 10 | 10 | 10 | 3.5 | 427.7 | 0.3 |
| | | 15 | 5 | 2.3 | 14.59 | |
| Bilevel General MIP | 20 | 10 | 10 | 2.6 | 39.01 | |
| | | 15 | 5 | 2.2 | 13.79 | |
| | 30 | 10 | 10 | 2.5 | 37.09 | |
| | | 15 | 5 | 3.2 | 0.23 | |
| | 10 | 10 | 10 | 67.1 | 1065.41 | 3.4 |
| | | 15 | 5 | 5.9 | 1.62 | |
| Bilevel Pure IP | 20 | 10 | 10 | 56.7 | 1094.55 | 3.0 |
| | | 15 | 5 | 24.7 | 361.15 | 1.9 |
| | 30 | 10 | 10 | 55.6 | 1095.06 | 10.5 |

From the results in Table 1, certain observations may be made: First, the techniques of the present invention demonstrate a very strong capability, especially for those problems with an MIP problem in the lower-level. Comparing to existing computational studies on similar instances [22, 36], a significant reduction in computation time or optimality gap can be observed. Certainly, due to different computational facilities, such comparison may not be fair. However, it is worth noting that an optimal solution can often be derived, after a couple of iterations, with the described reformulation and decomposition techniques. Those small numbers indicate that the disclosed techniques could compute bilevel MIP by solving just several (single-level) MIP problems (with complementarity constraints). Thus, the computational results strongly confirm the effectiveness of these techniques and their distinct advantages over existing methods.

Second, as expected, discrete variables in the lower-level clearly increase the computational burden, especially for those bilevel pure IP problems. Nevertheless, continuous variables and corresponding constraints in the lower-level MIP may be helpful. When the number of constraints increases, the number of iterations and/or computational time does not clearly increase. One explanation is that the rich primal and dual information from KKT conditions (or strong duality) assists in the rapid identification of critical values for discrete lower-level variables, leading to a fast convergence. This observation suggests that the presented techniques are scalable to deal with practical instances.

A structured interdiction problem, which arises from power system research and includes binary variables in both levels, can be solved by a multi-start Benders decomposition based heuristic method, as in Delgadillo et al. (Analysis of electric grid interdiction with line switching, Power Systems, IEEE Transactions on, 25(2):633-641, 2010; which is incorporated herein by reference). By using the disclosed techniques including the strong-duality-based reformulation, exact solutions generally can be obtained within a marginal computational time, compared to that of a heuristic based on Benders decomposition.

Also, a similar power grid protection problem (based on [14, 50]) is computed by a Branch-and-Bound method developed for the bilevel MIP problem in [49], which produces an optimal solution in more than 100 seconds. By directly applying the disclosed techniques, it can be computed within 2 seconds after a couple of iterations. Those comparisons, together with observations in Table 1, support the advantageousness of embodiments using techniques of the subject invention to compute challenging bilevel MIPs.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

All patents, patent applications, provisional applications, and publications referred to or cited herein (including those in the “References” section) are incorporated by reference in their entirety, including all figures and tables, to the extent they are not inconsistent with the explicit teachings of this specification.

### REFERENCES

[1] Jose M Arroyo and Francisco D Galiana. On the solution of the bilevel programming formulation of the terrorist threat problem. Power Systems, IEEE Transactions on, 20(2):789-797, 2005.
[2] Jose Manuel Arroyo. Bilevel programming applied to power system vulnerability analysis under multiple contingencies. Generation, Transmission & Distribution, IET, 4(2):178-190, 2010.
[3] Charles Audet, Pierre Hansen, Brigitte Jaumard, and Gilles Savard. Links between linear bilevel and mixed 0-1 programming problems. Journal of Optimization Theory and Applications, 93(2):273-300, 1997.
[4] Jonathan F Bard. An efficient point algorithm for a linear two-stage optimization problem. Operations Research, 31(4):670-684, 1983.
[5] Jonathan F Bard. Practical bilevel optimization: algorithms and applications, volume 30. Springer, 1998.
[6] Jonathan F Bard and James E Falk. An explicit solution to the multi-level programming problem. Computers & Operations Research, 9(1):77-100, 1982.
[7] Jonathan F Bard and James T Moore. A branch and bound algorithm for the bilevel programming problem. SIAM Journal on Scientific and Statistical Computing, 11(2):281-292, 1990.
[8] Jonathan F Bard, John Plummer, and Jean Claude Sourie. A bilevel programming approach to determining tax credits for biofuel production. European Journal of Operational Research, 120(1):30-46, 2000.
[9] Wayne Bialas and Mark Karwan. On two-level optimization. Automatic Control, IEEE Transactions on, 27(1):211-214, 1982.
[10] Daniel Bienstock and Abhinav Verma. The N-k problem in power grids: New models, formulations, and numerical experiments. SIAM Journal on Optimization, 20(5):2352-2380, 2010.
[11] Jerome Bracken and James T McGill. Mathematical programs with optimization problems in the constraints. Operations Research, 21(1):37-44, 1973.
[12] Luce Brotcorne, Martine Labbé, Patrice Marcotte, and Gilles Savard. A bilevel model for toll optimization on a multicommodity transportation network. Transportation Science, 35(4):345-358, 2001.
[13] Luce Brotcorne, Martine Labbé, Patrice Marcotte, and Gilles Savard. Joint design and pricing on a network. Operations Research, 56(5):1104-1115, 2008.
[14] Gerald G Brown, Matthew Carlyle, Javier Salmeron, and Kevin Wood. Analyzing the vulnerability of critical infrastructure to attack and planning defenses. In Tutorials in Operations Research. INFORMS, pages 102-123. INFORMS, 2005.
[15] Anthony P Burgard, Priti Pharkya, and Costas D Maranas. Optknock: a bilevel programming framework for identifying gene knockout strategies for microbial strain optimization. Biotechnology and bioengineering, 84(6):647-657, 2003.
[16] Wilfred Candler and Roger Norton. Multilevel programming and development policy. Technical Report 258, World Bank Staff, Washington, D.C., 1977.
[17] Wilfred Candler and Robert Townsley. A linear two-level programming problem. Computers & Operations Research, 9(1):59-76, 1982.
[18] R G Cassidy, M J L Kirby, and W M Raike. Efficient distribution of resources through three levels of government. Management Science, 17(8):462-473, 1971.
[19] Benoît Colson, Patrice Marcotte, and Gilles Savard. Bilevel programming: A survey. 4OR, 3(2):87-107, 2005.
[20] Jean-Philippe Côté, Patrice Marcotte, and Gilles Savard. A bilevel modelling approach to pricing and fare optimisation in the airline industry. Journal of Revenue and Pricing Management, 2(1):23-36, 2003.
[21] Andrés Delgadillo, José Manuel Arroyo, and Natalia Alguacil. Analysis of electric grid interdiction with line switching. Power Systems, IEEE Transactions on, 25(2):633-641, 2010.
[22] Scott DeNegre. Interdiction and discrete bilevel linear programming. Ph.D. thesis, Lehigh University, 2011.
[23] Steven P Dirkse and Michael C Ferris. The path solver: a nommonotone stabilization scheme for mixed complementarity problems. Optimization Methods and Software, 5(2):123-156, 1995.
[24] José Fortuny-Amat and Bruce McCarl. A representation and economic interpretation of a two-level programming problem. Journal of the Operational Research Society, 32(9):783-792, 1981.
[25] Antonio Frangioni. On a new class of bilevel programming problems and its use for reformulating mixed integer problems. European Journal of Operational Research, 82(3):615-646, 1995.
[26] Lina P Garcés, Antonio J Conejo, Raquel García-Bertrand, and Rubén Romero. A bilevel approach to transmission expansion planning within a market environment. Power Systems, IEEE Transactions on, 24(3):1513-1522, 2009.
[27] Pierre Hansen, Brigitte Jaumard, and Gilles Savard. New branch-and-bound rules for linear bilevel programming. SIAM Journal on Scientific and Statistical Computing, 13 (5): 1194-1217, 1992.
[28] Benjamin F Hobbs, Carolyn B Metzler, and J-S Pang. Strategic gaming analysis for electric power systems: An mpec approach. Power Systems, IEEE Transactions on, 15(2):638-645, 2000.
[29] Jing Hu, John E Mitchell, Jong-Shi Pang, Kristin P Bennett, and Gautam Kunapuli. On the global solution of linear programs with linear complementarity constraints. SIAM Journal on Optimization, 19(1):445-471, 2008.
[30] Jing Hu, John E Mitchell, Jong-Shi Pang, and Bin Yu. On linear programs with linear complementarity constraints. Journal of Global Optimization, 53(1):29-51, 2012.
[31] Xinmin Hu and Daniel Ralph. Convergence of a penalty method for mathematical programming with complementarity constraints. Journal of Optimization Theory and Applications, 123(2):365-390, 2004.
[32] Shan Jin and Sara M Ryan. A tri-level model of centralized transmission and decentralized generation expansion planning for an electricity market—part I. Power Systems, IEEE Transactions on, 29(1):132-141, 2014.
[33] Matthias Köppe, Maurice Queyranne, and Christopher Thomas Ryan. Parametric integer programming algorithm for bilevel mixed integer programs. Journal of Optimization Theory and Applications, 146(1):137-150, 2010.
[34] Churlzu Lim and J Cole Smith. Algorithms for discrete and continuous multicommodity flow network interdiction problems. IIE Transactions, 39(1):15-26, 2007.
[35] Pierre Loridan and Jacqueline Morgan. Weak via strong Stackelberg problem: New results. Journal of Global Optimization, 8(3):263-287, 1996.
[36] Patrice Marcotte. Network design problem with congestion effects: A case of bilevel programming. Mathematical Programming, 34(2): 142-162, 1986.
[37] James Moore and Jonathan Bard. The mixed integer linear bilevel programming problem. Operations Research, 38(5):911-921, 1990.
[38] Alexis L Motto, José M Arroyo, and Francisco D Galiana. A mixed-integer LP procedure for the analysis of electric grid security under disruptive threat. Power Systems, IEEE Transactions on, 20(3):1357-1365, 2005.
[39] Hrvoje Pandzic, Antonio J Conejo, Igor Kuzle, and Eduardo Caro. Yearly maintenance scheduling of transmission lines within a market environment. Power Systems, IEEE Transactions on, 27(1):407-415, 2012.
[40] George P Papavassilopoulos. Algorithms for static Stackelberg games with linear costs and polyhedra constraints. In Decision and Control, 1982 21st IEEE Conference on, volume 21, pages 647-652. IEEE, 1982.
[41] Arvind U Raghunathan and Lorenz T Biegler. An interior point method for mathematical programs with complementarity constraints (MPCCs). SIAM Journal on Optimization, 15(3):720-750, 2005.
[42] Shaogang Ren, Bo Zeng, and Xiaoning Qian. Adaptive bi-level programming for optimal gene knockouts for targeted overproduction under phenotypic constraints. BMC Bioinformatics, 14(Suppl 2):S17, 2013.
[43] Helena Sofia Rodrigues and M Teresa T Monteiro. Solving mathematical programs with complementarity constraints with nonlinear solvers. In Recent Advances in Optimization, pages 415-424. Springer, 2006.
[44] Carlos Ruiz and Antonio J Conejo. Pool strategy of a producer with endogenous formation of locational marginal prices. Power Systems, IEEE Transactions on, 24(4):1855-1866, 2009.
[45] Javier Salmeron, Kevin Wood, and Ross Baldick. Worst-case interdiction analysis of largescale electric power grids. Power Systems, IEEE Transactions on, 24(1):96-104, 2009.
[46] Maria P Scaparra and Richard L Church. A bilevel mixed-integer program for critical infrastructure protection planning Computers & Operations Research, 35 (6): 1905-1923, 2008.
[47] Holger Scheel and Stefan Scholtes. Mathematical programs with complementarity constraints: Stationarity, optimality, and sensitivity. Mathematics of Operations Research, 25(1):1-22, 2000.
[48] Hoang Tuy, Athanasios Migdalas, and Peter Värbrand. A global optimization approach for the linear two-level program. Journal of Global Optimization, 3(1):1-23, 1993.
[49] Ue-Pyng Wen and Y H Yang. Algorithms for solving the mixed integer two-level linear programming problem. Computers & Operations Research, 17(2):133-142, 1990.
[50] Pan Xu. Three essays on bilevel optimization algorithms and applications. Ph.D. thesis, Iowa State University, 2012.
[51] Pan Xu and Lizhi Wang. An exact algorithm for the bilevel mixed integer linear programming problem under three simplifying assumptions. Computers & Operations Research, 41(1):309-318, 2014.
[52] Yiming Yao, Thomas Edmunds, Dimitri Papageorgiou, and Rogelio Alvarez. Trilevel optimization in power network defense. Systems, Man, and Cybernetics, Part C: Applications and Reviews, IEEE Transactions on, 37(4):712-718, 2007.
[53] Wei Yuan, Long Zhao, and Bo Zeng. Optimal power grid protection through a defender-attacker-defender model. Reliability Engineering & System Safety, 121:83-89, 2014.
[54] Bo Zeng and Long Zhao. Solving two-stage robust optimization problems using a column-and-constraint generation method. Operations Research Letters, 41(5):457-461, 2013.
[55] Long Zhao and Bo Zeng. Vulnerability analysis of power grids with line switching. Power Systems, IEEE Transactions on, 28(3):2727-2736, 2013.

We claim:

1. A system for performing a bi-level optimization, the system comprising:
one or more computer readable storage media;
program instructions stored on at least one of the one or more computer readable storage media that, when executed by a processing system, direct the processing system to:
in response to receiving a Bilevel Mixed Integer Programming (BiMIP) problem, wherein the BiMIP has a feasible high point problem and the BiMIP has a lower-level problem having a finite optimal solution:
alter the BiMIP problem to a BiMIP_{d} formulation;
separate the BiMIP_{d} into a master problem and a subproblem, the master problem being reformulated to one of a single-level equivalent formulation, an extended formulation, a strong-duality-based equivalent formulation, and an augmented formulation;
determine an optimal BiMIP solution, an optimal upper bound, and an optimal lower bound by iteratively solving the master problem and the subproblem, using a result set from a previous iteration as one or more constraint in a next iteration until an upper bound is within an optimality tolerance (ε) of a lower bound; and
return the optimal BiMIP solution, the optimal upper bound, and the optimal lower bound.

2. The system of claim 1, wherein the BiMIP_{d} formulation is:
BiMIP_{d}:Θ*=min fx+gy⁰ (12)
s.t. Ax≦b, x∈ [symbol] ₊^{m}^{_{c}}x [symbol] ₊^{m}^{ₛ}, (13)
Py⁰+Nz⁰≦R−Kx, y⁰∈ [symbol] ₊ⁿ^{_{c}},z⁰∈ [symbol] ₊ⁿ^{_{d}}, (14)
wy⁰+vz⁰≧max{wy+vz:Py+Nz≦R−Kx,y∈ [symbol] ₊ⁿ^{_{c}},∈ [symbol] ₊ⁿ^{_{d}}}, (15)

3. The system of claim 1, wherein the BiMIP has a relatively complete response property and the single-level equivalent formulation of the master problem is:
MP: Θ*=min fx+gy⁰+hz⁰ (39)
s.t. Ax≦b, x∈ [symbol] ₊^{m}^{_{c}}x [symbol] ₊^{m}^{_{d}}, (13)
Py⁰+Nz⁰≦R−Kx,y⁰∈ [symbol] ₊ⁿ^{_{c}},z⁰∈ [symbol] ₊ⁿ^{_{d}},(14)
wy⁰vz⁰≧vz^{j}+wy^{j},1≦j≦l (40)
Py^{j}≦R−Kx−Nz^{j},P^{t}π^{j}≧w^{t},1≦j≦l (41)
y^{j}⊥(P^{t}π^{j}−w^{t}),π^{j}⊥(R−Kz−Nz^{j}−Py^{j}),1≦j≦l (42)
y^{j}∈ [symbol] ₊ⁿ^{_{c}},π^{j}∈ [symbol] ₊ⁿ^{ₗ}, 1≦j≦l. (43)

4. The system of claim 1, wherein the BiMIP does not have the relatively complete response property and the extended formulation is:
$$\begin{matrix} {BiMIP}_{d} \text{:} {Θ}^{*} = min fx + {gy}^{0} + {hz}^{0} & ( 12 ) \\ s . t . Ax \leq b , x ∈ {ℝ}_{+}^{{m}_{c}} \times {ℤ}_{+}^{{m}_{d}} , & ( 13 ) \\ {Py}^{0} + {Nz}^{0} \leq R - Kx , {y}^{0} ∈ {ℝ}_{+}^{{n}_{c}} , {z}^{0} ∈ {ℤ}_{+}^{{n}_{d}} , & ( 14 ) \\ {wy}^{0} + {vz}^{0} \geq {max}_{ } \{ \begin{matrix}wy + vz - M {\sum }_{i} {\tilde{y}}_{i} \text{:} Py + Nz \leq R - Kx + I \tilde{y} , \\ ( y , \tilde{y} ) ∈ {ℝ}_{+}^{{n}_{c + {n}_{1}}} , z ∈ {ℤ}_{+}^{{n}_{d}}\end{matrix} \} & ( 25 )\end{matrix}$$

5. The system of claim 1, wherein the strong-duality-based equivalent formulation is:

6. The system of claim 1, wherein the augmented formulation is:
MP_{aug}:Θ*min fx+gy⁰+hz⁰ (45)
s.t. Ax≦b.x∈ [symbol] ₊^{m}^{_{c}}x [symbol] ₊ⁿ^{_{d}}, (13)
Py⁰+Nz⁰≦R−Kx,y⁰∈ [symbol] ₊ⁿ^{_{d}},z⁰∈ [symbol] ₊ⁿ^{_{d}}, (14)
wy⁰+vz⁰≧vz^{j}+wy^{j},1≦j≦l (40)
Py^{j}≦R−Kz−Nz^{j},P^{t}π^{j}≧w^{t},1≦j≦l (41)
y^{j}⊥(P^{t}π^{j}−w^{t}),π^{j}⊥(R−Kz−Nz^{j}−Py^{j}),1≦j≦l (42)
y^{j}∈ [symbol] ₊ⁿ^{_{c}},π^{j}∈ [symbol] ₊ⁿ^{_{d}},1≦j≦l. (43)
wy⁰+vz⁰≧vz⁰+wŷ (46)
Pŷ≦R−Kx−Nz⁰,P^{t}\hat{π}≧w^{t} (47)
ŷ⊥(P^{t}\hat{π}−w^{t}), \tilde{π}⊥(R−Kz−Nz⁰−P\tilde{y}) (48)
ŷ∈ [symbol] ₃₀ ⁿ^{_{c}},\tilde{π}∈ [symbol] ₊ⁿ^{_{d}}, (49)
and wherein ŷ and \hat{π} represent primal and dual variables corresponding to (x, z⁰.

7. The system of claim 1, wherein the program instructions to determine the BiMIP solution comprise instructions that direct the processing system to:
set LB=−∞, UB=+∞, and l=0;
perform the following steps iteratively:
(a) determine a master problem solution (Θ*) for
(x*, y⁰*, z⁰*, y¹*, . . . , y^{l}*, . . . , π^{l}*), and set LB=Θ*;
(b) if UB−LB≦ε, set the optimal upper bound to UB, set the optimal lower bound to
LB, store the optimal BiMIP solution (x*, z*), and stop iterating;
(c) solve a first part of the subproblem for a given x*, wherein the first part is:
θ(x*)=max{wy+vz: Py+Nz≦R−Kx*, y∈ [symbol] ₊ⁿ^{_{c}}, z∈ [symbol] ₊ⁿ^{_{d}}},
(d) when the subproblem has multiple optimal solutions for x*, solve a second part of the subproblem, wherein the second part is
Θ_{ƒ}(x*)=min{gy+hz: wy+vz≧Θ(x*); Py+Nz≦R−Kx*, y∈ [symbol] ₊ⁿ^{_{c}}, z∈ [symbol] ₊ⁿ^{_{d}}},
(e) determine an optimal subproblem solution to (y*, z*);
(f) update UB=min {UB, fx*+Θ_{ƒ}(x*)};
(g) set z^{l+1}=z*, create variables (y^{l+1}, π^{l+1}), and add the one or more constraint to the master problem; and
(h) set l=l+1, and repeat Step (a).

8. The system of claim 7, wherein the one or more constraint comprises:
wy⁰+vz⁰≧vz^{l+1}+wy^{l+1},
Py^{l+1}≦R−Kz−Nz^{l+1}, P^{t}π^{l+}≧w^{t},
y^{l+1}⊥(P^{t}π^{l+1}−w^{t}), π^{l+1}⊥(R−Kx−Nz^{l+1}−Py^{l+1}),
y^{l+1}∈ [symbol] ₊ⁿ^{_{c}}, π^{l+1}∈ [symbol] ₊ⁿ^{₁}

9. The system of claim 1, wherein the BiMIP problem is a structured interdiction problem and the second part of the sub-problem in step (d) is not solved.

10. The system of claim 1, wherein a lower-level decision variable of the BiMIP problem is a continuous variable, and the master problem is the single-level equivalent formulation.

11. A method for performing a bi-level optimization within a software application, the method comprising:
receiving a Bilevel Mixed Integer Programming (BiMIP) problem, wherein the BiMIP has a feasible high point problem and the BiMIP has a lower-level problem having a finite optimal solution;
alter the BiMIP problem to a BiMIP_{d} formulation;
separate the BiMIP_{d} into a master problem and a subproblem, the master problem being reformulated to one of a single-level equivalent formulation, an extended formulation, a strong-duality-based equivalent formulation, and an augmented formulation;
determine an optimal BiMIP solution, an optimal upper bound, and an optimal lower bound by:
setting LB=−∞, UB=+∞, and l=0;
performing the following steps iteratively:
(a) determine a master problem solution (Θ*) for
(x*, y⁰*, z⁰*, y¹*, . . . , y^{l}*, π¹*, . . . , π^{l}*), and set LB=Θ*;
(b) if UB−LB≦ε, set the optimal upper bound to UB, set the optimal lower bound to
LB, store the optimal BiMIP solution (x*, z*), and stop iterating;
(c) solve a first part of the subproblem for a given x*, wherein the first part is:
θ(x*)=max{wy+vz: Py+Nz≦Kx*, y∈ [symbol] ₊ⁿ^{_{c}}, z∈ [symbol] ₊ⁿ^{_{d}}},
(d) when the subproblem has multiple optimal solutions for x*, solve a second part of the subproblem, wherein the second part is)
Θ_{ƒ}(x*)=min {gy+hz: wy+vz≧θ(x*), Py+Nz≦R−Kx*, y ∈ [symbol] ₊ⁿ^{_{c}}, z ∈ [symbol] ₊ⁿ^{_{d}}}.
(e) determine an optimal subproblem solution to (y*, z*);
(f) update UB=min {UB, fx*+Θ_{ƒ}(x*)};
(g) set z^{l+1}=z*, create variables (y^{l+1}, π^{l+1}), and add the one or more constraint to the master problem; and
(h) set l=l+1, and repeat Step (a); and
return the optimal BiMIP solution, the optimal upper bound, and the optimal lower bound.

12. The method of claim 11, wherein the BiMIP_{d} formulation is:
BiMIP_{d}:Θ*=minfx+gy⁰+hz⁰ (12)
s.t. Ax≦b, x∈ [symbol] ₊^{m}^{_{c}}+ [symbol] ₊^{m}^{_{d}}, (13)
Py⁰+Nz⁰≦R−Kx, y⁰∈ [symbol] ₊ⁿ^{_{c}}, z⁰∈ [symbol] ₊ⁿ^{_{d}}, (14)
wy⁰+vz⁰≧max{wy+vz:Py+Nz≦R−Kx,y∈ [symbol] ₊ⁿ^{_{c}},z∈ [symbol] ₊ⁿ^{_{d}}}. (15)

13. The method of claim 11, wherein the BiMIP has a relatively complete response property and the single-level equivalent formulation of the master problem is:
MP:Θ*=min fx+gy⁰+hz⁰ (39)
s.t. Ax≧b. x∈ [symbol] ₊ⁿ^{_{c}}× [symbol] ₊ⁿ^{_{d}}, (13)
Py+Nz⁰≦R−Kx, y⁰∈ [symbol] ₊ⁿ^{_{c}},z⁰∈ [symbol] ₊ⁿ^{_{d}}, (14)
wy⁰+vz⁰≧vz^{j}+wy^{j},1≦j≦l (40)
Py^{j}≦R−Kx−Nz^{j},P^{t}π^{j}≧w^{t},1≦j≦l (41)
y^{j}⊥(P^{t}π^{j}−w^{t}),π^{j}⊥(R−Kx−Nz^{j}−Py^{j}),1≦j≦l (42)
y^{j}∈ [symbol] ₊ⁿ^{_{c}}l ,π^{j}∈ [symbol] ₊ⁿ^{₁},1≦j≦l (43)

14. The method of claim 11, wherein the BiMIP does not have the relatively complete response property and the extended formulation is:
$$\begin{matrix} {BiMIP}_{d} \text{:} {Θ}^{*} = min fx + {gy}^{0} + {hz}^{0} & ( 12 ) \\ s . t . Ax \leq b , x ∈ {ℝ}_{+}^{{m}_{c}} \times {ℤ}_{+}^{{m}_{d}} , & ( 13 ) \\ {Py}^{0} + {Nz}^{0} \leq R - Kx , {y}^{0} ∈ {ℝ}_{+}^{{n}_{c}} , {z}^{0} ∈ {ℤ}_{+}^{{n}_{d}} , & ( 14 ) \\ {wy}^{0} + {vz}^{0} \geq {max}_{ } \{ \begin{matrix}wy + vz - M {\sum }_{i} {\tilde{y}}_{i} \text{:} Py + Nz \leq R - Kx + I \tilde{y} , \\ ( y , \tilde{y} ) ∈ {ℝ}_{+}^{{n}_{c + {n}_{1}}} , z ∈ {ℤ}_{+}^{{n}_{d}}\end{matrix} \} & ( 25 )\end{matrix}$$

15. The method of claim 11, wherein the strong-duality-based equivalent formulation is:
Σ_{z}^{d}:min fx+gy⁰+hz⁰ (30)
s.t. Ax≦b,x∈ [symbol] ₊ⁿ^{_{c}},x [symbol] ₊ⁿ^{_{d}}, (13)
Py⁰+Nz⁰≦R−Kx,y⁰∈ [symbol] ₊ⁿ^{_{c}},z⁰∈ [symbol] ₊ⁿ^{_{d}}, (14)
wy⁰+vz⁰≧vz^{j}+(R−Kx−Nz^{j})^{t}π^{j},1≦j≦k (32)
P^{t}π^{j}≧w^{t},1≦j≦k (33)
π^{j}∈ [symbol] ₊ⁿ^{₁}, 1≦j≦k, (34)

16. The method of claim 11, wherein the augmented formulation is:
MP_{aug}:Θ*=minfx+gy⁰+hz⁰ (45)
s.t. Ax≦b.x∈ [symbol] ₊^{m}^{_{c}}× [symbol] ₊^{m}^{_{d}}, (13)
Py⁰+Nz⁰≦R−Kx,y^{0∈} [symbol] ₊ⁿ^{_{c}}^{0∈} [symbol] ₊ⁿ^{_{d,}} (14)
wy⁰+vz⁰≧vz^{j}wy^{j},1≦j≦l (40)
Py^{j}≦R−Kx−Nz^{j},P^{t}π^{j}≧w^{t},1≦j≦l (41)
y^{j}⊥(P^{t}π^{j}−w^{t}),π^{j}⊥(R−Kx−Nz^{j}−Py^{j}(,1≦j≦l (42)
y^{j}∈ [symbol] ₊ⁿ^{_{c}},π^{j}∈ [symbol] ₊ⁿ^{₁}, 1≦j≦l. (43)
wy⁰+vz⁰≧vz⁰+wŷ (46)
Pŷ≦R−Kx−Nz⁰,P^{t}\hat{π}≧w^{t} (47)
ŷ⊥(P^{t}\hat{π}−w^{t}),\hat{π}⊥(R−Kx−Nz⁰−Pŷ) (48)
ŷ∈ [symbol] ₊ⁿ^{_{c}},\hat{π}∈ [symbol] ₊ⁿ^{₁}, (49)
and wherein ŷ and \hat{π} represent primal and dual variables corresponding to (x, z⁰).

17. The method of claim 11, wherein the one or more constraint comprises:
wy⁰+vz⁰≧vz^{l+1}+wy^{l+1},
Py^{l+1}≦R−Kx−Nz^{l+1}, P^{t}π^{l+1}≧w^{t},
y^{l+1} ⊥(P^{t}π^{l+1}−w^{t}), π^{l+1} ⊥(R−Kz−Nz^{l+1}−Py^{l+1}),
y^{l+1} ∈ [symbol] ₊ⁿ^{_{c}}, π^{l+1} ∈ [symbol] ₊ⁿ^{₁}

18. The method of claim 11, wherein the BiMIP problem is a structured interdiction problem and the second part of the sub-problem in step (d) is not solved.

19. The method of claim 11, wherein an upper-level decision variable of the BiMIP problem is a binary variable, and the master problem is the strong-duality-based equivalent formulation.

20. The method of claim 11, wherein a lower-level decision variable of the BiMIP problem is a continuous variable, and the master problem is the single-level equivalent formulation.
